(19) United States
(12) Patent Application Publication
(10) Pub. No.: US 2004/0212906 A1
(43) Pub. Date: Oct. 28, 2004

(54) Internal rear-view mirror for motor vehicles

(76) Inventors: Andreas Heim, Esslingen (DE); Werner Stuffle, Remseck (DE)

Correspondence Address: Warn, Hoffmann, Miller & LaLone, P.C., P.O. Box 70098, Rochester Hills, MI, 48307, US

(21) Appl. No.: 10/675,482

(22) Filed: Sep. 30, 2003

(30) Foreign Application Priority Data
Oct. 5, 2002 (DE) 102 46 585.1

(51) Int. Cl. G02B 7/182

(52) U.S. Cl. 359/871

(57) ABSTRACT

Interior rearview mirror for motor vehicles

Interior rearview mirrors for motor vehicles are known in whose mirror housing is arranged a speaker. However, the sound they produce frequently does not satisfy sound quality requirements in motor vehicles.

So that the interior rearview mirror ensures high quality of sound reproduction from its speaker while being easy to assemble, the speaker is part of a bass reflex system that is accommodated in the mirror housing. The result of this design is optimum sound quality. The bass reflex system can simply be built into the mirror housing with no additional installation space required.

The interior rearview mirror is installed in motor vehicles.

### FIELD OF THE INVENTION

The present invention relates to an interior rear-view mirror for motor vehicles in accordance with the preamble to claim 1.

### BACKGROUND OF THE INVENTION

For many years, motor vehicles have made increasing use of so-called centerfill loudspeakers that are built into the area of the dashboard and improve the sound quality of the vehicle's audio system. Since increasingly stringent requirements on sound quality and other sound features such as surround sound in the vehicle place increased demands on and require higher power levels from such centerfill loudspeakers, very powerful or large speakers are needed which are coupled from approximately 200 Hz and up. Such speakers are frequently built into the area of the ventilating grill in the vicinity of the defroster or the air conditioner sensor in the dashboard. The size of the covers required causes difficulties from an esthetic viewpoint since speaker grills are considered ugly. Moreover, the outlet area, for example in the vicinity of the defroster outlet, is sometimes smaller than the diameter of the loudspeaker. This can cause difficulties in defrosting the windshield. Furthermore, the speaker can only be replaced with difficulty in the event of a repair since it is sometimes necessary to disassemble the entire dashboard panel.

Different audio packages are frequently used for different vehicle models, and a centerfill speaker often is not installed in the base model. This is why a relatively large number of variants is needed to specially equip the sound system with a centerfill speaker.

Interior rear-view mirrors are also known wherein speakers are built into the mirror housing, however the sound they produce does not satisfy modern sound quality requirements in motor vehicles.

The object of the invention is to design an interior rear-view mirror of this type such that it ensures high quality of sound reproduction while being easy to assemble.

This object is attained by the generic interior rear-view mirror in accordance with the invention with the characterizing features of claim 1.

In the interior rear-view mirror in accordance with the invention, the speaker is not merely built into the interior of the mirror housing, it is instead designed as part of a bass reflex system. This bass reflex system is accommodated in the mirror housing. The speaker of said bass reflex system constitutes the centerfill speaker. It is advantageously installed such that its sound waves are reflected by the vehicle's windshield. The result is optimum sound quality. The bass reflex system can simply be built into the mirror housing in this context. It is not visible to the driver and requires no additional installation space inside the vehicle.

Additional features of the invention are readily apparent from the additional claims, the description and the drawings. Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

The invention is described in detail on the basis of an example embodiment shown in the drawings.

### BRIEF DESCRIPTION OF THE DRAWINGS

The present invention will become more fully understood from the detailed description and the accompanying drawings, wherein:

FIG. 1 shows a top view of an interior rear-view mirror in accordance with the invention;

FIG. 2 shows a bottom view of a part of the interior rear-view mirror in accordance with the invention;

FIG. 3 shows a cross-section through the interior rear-view mirror in accordance with the invention.

### DETAILED DESCRIPTION OF THE PREFERRED EMBODIMENTS

The following description of the preferred embodiment(s) is merely exemplary in nature and is in no way intended to limit the invention, its application, or uses.

The interior rear-view mirror is intended for motor vehicles and has a mirror housing 1 that is connected to a mirror base 2 in a known manner. It is fastened to the roof of the passenger compartment of the motor vehicle and is located below a mirror base cover 3.

It is also possible to glue the mirror base 2 to the windshield 4 of the motor vehicle. The mirror housing 1 can be moved relative to the mirror base 2 such that the interior rear-view mirror can be adjusted precisely for the driver of the motor vehicle.

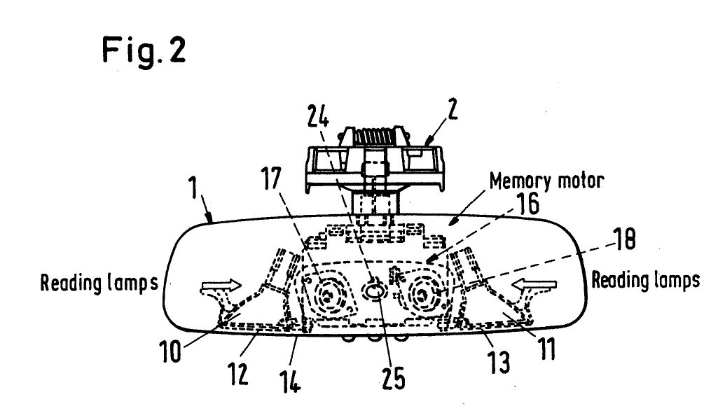

The mirror housing 1 has a rear wall 5 that faces the windshield 4 and, in the example embodiment, is of curved design and transitions into a surrounding side wall 6. The latter delimits an installation opening 7 facing the rear wall 5 at a distance for a mirror 8. This may be a wedge mirror, EC mirror, LCD mirror, or a conventional mirror with which no dimming is possible. The rear wall 5 and the side wall 6 delimit an installation space 9 which accommodates a wide variety of components of the interior rear-view mirror. In the example embodiment, the installation space holds two reading lamps 10, 11, which may be incandescent lamps, LEDs or other illuminating means. The light they emit passes through the respective optical windows 12, 13 (FIG. 2) into the passenger compartment. The optical windows 12, 13 are placed in the bottom 14, which is equipped with suitable openings in which the optical windows 12, 13 are placed. It is advantageous for the optical windows 12, 13 to be placed in the openings in the housing bottom 14 such that they are flush with the outside of the bottom 14. Naturally, the optical windows 12, 13 can also project slightly from or be slightly recessed into the outside of the bottom 14. In this regard, it is possible to design the optical windows 12, 13 and the installation openings in the bottom 14 such that the optical windows 12, 13 can be removed from outside when necessary, so that the mirror housing 1 need not be opened. For example, the optical windows 12, 13 snap into the installation openings in the bottom 14 of the mirror housing 1. The latching elements here are accessible from the outside, for example using a screwdriver that can be inserted through a slot between the edge of the relevant optical window 12, 13 and the edge of the opening in order to be able to move the relevant latching element to its release position.

In addition, at least one weak light source, preferably an LED, can be provided in the installation space 9, the light from which falls through an opening in the bottom 14 of the mirror housing 1 into the passenger compartment. This light source is designed and arranged such that it has only a very low intensity. This light source serves solely to illuminate parts of the dashboard or center console of the motor vehicle such that they are easily recognizable to the driver in the dark, but without the light dazzling the driver. The intensity of this light source is significantly lower than that of the light emitted by the reading lamps 10, 11.

Each of the two reading lamps 10, 11 can be switched on independently of the other by a separate switch. The additional light source can be switched on automatically when the motor vehicle ignition is turned on. It is further possible to couple this light source with the switch for the vehicle headlights such that the light source is switched on when the vehicle headlights are switched on.

Additional components can be built into the installation space 9 of the mirror housing 1, such as transmitters and/or receivers for garage door openers, sensors as part of the control system for the EC or LCD mirror, antennas for car radios, compasses and the like.

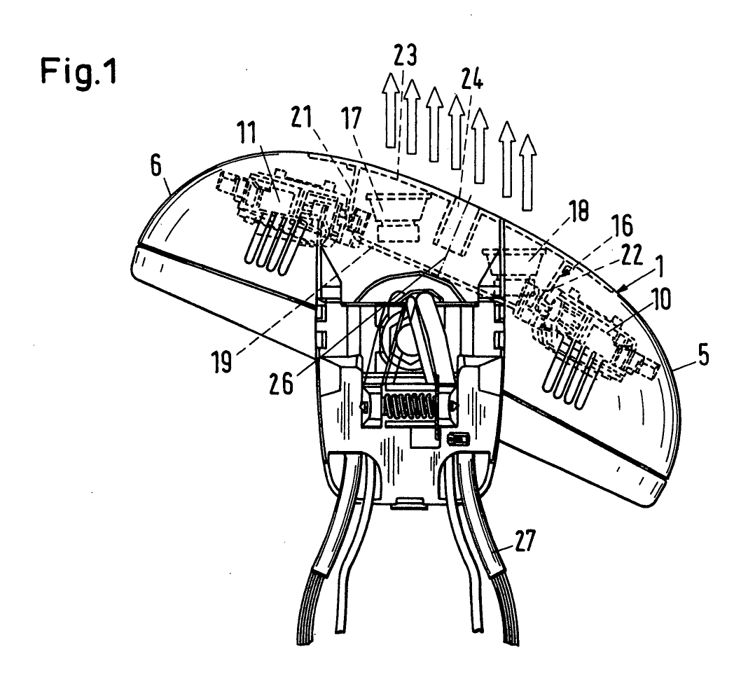

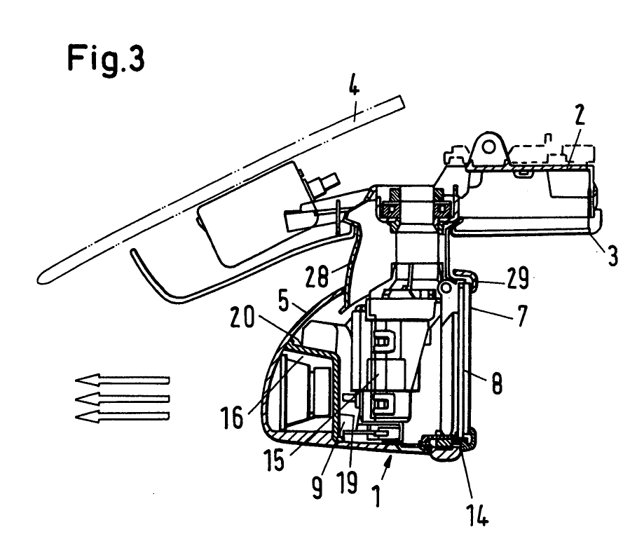

Provided in the installation space 9 is a closed chamber 16 that in the example embodiment holds two speakers 17, 18. The chamber 16 is delimited with respect to the mirror 8 by a rear wall 19 that extends from the bottom 14 of the mirror housing 1 and transitions at a distance from the bottom 14 into a transverse wall 20 that connects to the inside of the rear wall 5 of the mirror housing 1. The rear wall of the chamber 16 can also be formed by the mirror 8. Adjoining the rear wall 19 and the transverse wall 20 at the ends in the longitudinal direction are side walls 21, 22 (FIG. 1) that extend to the inside of the rear wall 5 of the mirror housing 1. The side walls 21, 22 extend from the housing bottom 14 to the transverse wall 20. As FIG. 1 shows, the side walls 21, 22 extend from the rear wall 19 and diverge in the direction of the rear wall 5 of the mirror housing 1. In so doing, the side walls 21, 22 adjoin the rear wall 5 at an angle that differs from 90°. The transverse wall 20 adjoins the rear wall 19 at an obtuse angle (FIG. 3). The rear wall 19, the transverse wall 20, and the side walls 21, 22 are all smooth and designed as a single piece with one another and with the mirror housing 1. The rear wall 19 only extends over part of the height of the mirror housing 1. In the example embodiment, the rear wall 19 is only half the maximum height of the mirror housing 1. The distance of the rear wall 19 from the rear wall 5 of the mirror housing 1 is shorter than from the mirror 8.

The rear wall 19, the transverse wall 20, the side walls 21, 22, and part of the rear wall 5 delimit the speaker chamber 16, which is located halfway along the length of the mirror housing 1 and is symmetric about the plane of its transverse center. The chamber 16 is airtight with respect to the installation space 9 of the mirror housing 1. The aforementioned walls 19-22 of the chamber 16 can be welded air-tight to the bottom 14 and the rear wall 5 of the mirror housing 1. However, these walls 19-22 that together form a unit may also be clipped onto the rear wall 5 and/or the bottom 14 of the mirror housing 1 or screwed onto the rear wall 5 and the bottom 14. The chamber 16 can also be designed as a plug-in module that is placed in the mirror housing 1 at a later time, for example clipped into place. In this case, the speakers 17, 18 located in the chamber 16 can be connected via plug-in contacts to corresponding contacts on the mirror housing.

The chamber 16 in the example embodiment has a volume of approximately 0.1 to 0.3 I. The rear wall 5 of the mirror housing 1 is provided with an outlet 23 (FIG. 1) at the height of the chamber 16 through which the sound produced by the speakers 17, 18 can pass out of the mirror housing 1 or chamber 16 to the outside toward the windshield 4. This outlet 23 can be injection molded in the rear wall 5, but can also be a separate speaker grill that is, for example, clipped into a corresponding opening in the rear wall 5. The grill-like outlet 23 is preferably made of the same material as the mirror housing 1.

The chamber 16 is located in the region between the reading lamps 10, 11. The speakers 17, 18 are fastened to the rear wall 19 of the chamber 16. Located between the two speakers 17, 18 is a bass reflex port 24 that extends from the inside of the rear wall 5 of the mirror housing 1 into the chamber 16 and ends a distance away from its rear wall 19 (FIGS. 1 and 2). The outlet grill 23 has a corresponding outlet opening 25 to which the bass reflex port 24 is connected. The axis 26 of the bass reflex port 24 is perpendicular to the rear wall of the mirror housing when seen in a top view of the mirror housing 1 (FIG. 1).

The two speakers 17, 18 can be adjusted to a limited extent about an axis of rotation perpendicular to their axis by a motor 15, preferably a memory motor. This makes it possible to optimally adjust the speakers 17, 18 independent of the position to which mirror housing 1 is set with respect to the mirror base 2. The speakers 17, 18 are oriented forward in the direction of travel or at only a slight angle to the direction of travel when the mirror housing 1 is oriented toward the driver, so that the speakers 17, 18 can be adjusted for different seat positions. The longitudinal axis of the speakers 17, 18 thus does not lie parallel to the surface of the mirror 8.

The chamber 16, together with the speakers 17, 18 and the bass reflex port 24, forms a bass reflex system with which superior sound can be produced in the passenger compartment of the motor vehicle. The bass reflex system is located invisibly inside the mirror housing and, in particular, requires no additional installation space. The speakers 17, 18 can be optimally adjusted, in particular to the conditions in the passenger compartment of the vehicle, by the length and/or the diameter of the bass reflex port 24 and the volume of the chamber 16.

Connected to the speakers 17, 18 are speaker cables that are combined into a cable harness 27 that passes in a sealed fashion through the mirror base 2 and a connecting sleeve 28 located between said base and the mirror housing 1 and into the installation space 9 of the mirror housing. However, contact to the speakers 17, 18 can also be made by any other suitable plug-in connection, if desired directly on the mirror housing 1.

Since the speakers 17, 18 are centered with respect to the transverse center plane of the mirror housing 1, the result is an optimum center of mass for the mirror housing 1. This results in only very slight vibration of the interior rear-view mirror, since the center of mass is very close to the mirror base 2 and thus is securely suspended from the mirror base 2. This is also advantageous for the vibrations that the speakers 17, 18 themselves produce and transmit to the mirror housing 1 or the mirror 8.

In a variation from the example embodiment shown, the bass reflex system 16, 24 can also be arranged asymmetrically with respect to the transverse center plane of the mirror housing 1.

Since the speakers 17, 18 can be adjusted in the described manner relative to the position of the mirror housing 1 and to the driver position, it is possible to implement variants for right-hand steering and left-hand steering. In a right-hand steering variant, the cable harness 27 is led in at a different point in the mirror base 2, as shown in FIG. 1 by dashed lines.

Orientation of the speakers 17, 18 is accomplished in the described manner by the motor 15, which advantageously is a memory motor, by means of which various positions of the speakers can be stored. In this way the speakers 17, 18 can easily be moved to the stored position so that the speakers can be optimally adjusted for different drivers. However, the speakers 17, 18 can also be oriented by such means as a camera (not shown) that likewise is advantageously accommodated in the mirror housing 1 and is pointed at the driver through the mirror 8. The camera can also be arranged to view through an opening in the mirror housing 1 or its edge 29 that extends around the mirror 8. The camera preferably senses the head position of the driver and adjusts the speakers 17, 18 accordingly.

It is possible to arrange only a single speaker or more than two speakers in the chamber 16. In this event, the volume of the chamber 16 and the size of the bass reflex port 24 are adjusted accordingly.

The description of the invention is merely exemplary in nature and, thus, variations that do not depart from the gist of the invention are intended to be within the scope of the invention. Such variations are not to be regarded as a departure from the spirit and scope of the invention.

1. An interior rear-view mirror for motor vehicles comprising:
a mirror housing in which at least one speaker is arranged, said speaker being part of a bass reflex system.

2. The interior rear-view mirror of claim 1, wherein the bass reflex system has at least one chamber that is sealed airtight with respect to the installation space of the mirror housing.

3. The interior rear-view mirror of claim 2, wherein the chamber holds at least one bass reflex port.

4. The interior rear-view mirror of claim 3, wherein the bass reflex port connects to an opening in a rear wall of the mirror housing.

5. The interior rear-view mirror of claim 3, wherein said bass reflex port terminates a distance away from a rear wall of the chamber.

6. The interior rear-view mirror of claim 5, wherein the rear wall of the chamber joins a top wall and side walls of the chamber to a bottom and the rear wall of the mirror housing.

7. The interior rear-view mirror of claim 6, wherein the rear wall, the top wall and the side walls of the chamber are designed as a single piece with one another.

8. The interior rear-view mirror of claim 5, characterized in that the front wall of the chamber opposite the rear wall is formed by a part of the rear wall of the mirror housing.

9. The interior rear-view mirror of claim 1, wherein the chamber with bass reflex port and speakers is designed as a plug-in module.

10. (Cancelled)

11. (Cancelled)

12. The interior rear-view mirror, particularly of claim 1, wherein the speaker can be oriented.

13. The interior rear-view mirror of claim 10, wherein the speaker can be oriented by a memory drive.

14. The interior rear-view mirror of claim 11, wherein the memory drive is located in the mirror housing.

15. The interior rear-view mirror of claim 1, wherein the bass reflex system has two speakers located next to one another and a distance apart.

16. The interior rear-view mirror of claim 13, wherein the bass reflex port is located in the region between the two speakers.

17. The interior rear-view mirror of claim 1, wherein the speaker is attached to the rear wall of the chamber.

18. The interior rear-view mirror of claim 1, wherein the bass reflex system is located in the region between the bottom and the rear wall of the mirror housing.

19. The interior rear-view mirror of claim 1, characterized in that the bass reflex system is arranged symmetrically with respect to a transverse center plane of the mirror housing.
